(19) United States
(12) Patent Application Publication
(10) Pub. No.: US 2009/0013837 A1
(43) Pub. Date: Jan. 15, 2009

(54) ELECTRONIC TENSION MEASURED SPANNER WITH A SLOT FOR CONNECTING A MEMORY DEVICE

(76) Inventor: Chih-Ching Hsieh, Taichung City (TW)

Correspondence Address: Chih-Ching HSIEH, 235 Chung - Ho Box 8-24, Taipei, 235, TW

(21) Appl. No.: 11/775,876

(22) Filed: Jul. 11, 2007

(51) Int. Cl. B25B 23/159

(52) U.S. Cl. 81/479; 81/467

(57) ABSTRACT

An electronic tension measured spanner with a slot for connecting a memory device, comprise: a handle; a head extends from one end of the handle for engaging a screwing object; a display unit installed in the handle; a strain gauge installed in the head or the handle for measuring the tension in the operation of the spanner; the tension measured by the strain gauge will be transferred to the display unit for displaying; and a slot formed in the handle and electrically connected to the display unit. A memory device is insertable into the slot for receiving the data from the display unit. The slot is a USB slot. The head is one of an opened head, a ring and a socket driver. Another head is connected to another end of the handle. The memory device is a memory card or a flash disk.

### FIELD OF THE INVENTION

The present invention relates to spanners, and particularly to an electronic tension measured spanner with a slot for connecting a memory device, in that a memory device can be connected to the spanner for recoding data in operation.

### BACKGROUND OF THE INVENTION

Spanners are frequently used in works. Generally, a spanner has a head for driving a screwing object. In some works, it is necessary to control the force applied to the screwing object so as to prevent the spanner or screwing object from damage or giving a proper engaging level to the screwing object so that it can be locked to an object properly. Thus electronic spanner is developed.

In the electronic spanner, a strain gauge is installed to the spanner. The strain gauge is generally installed at a connection of the handle and the head of the spanner so as to measure the react force from the screwing object to the head of the spanner. Then the measured data in the strain gauge is transferred to a display on the spanner.

However this prior art still has a defect that the measured tension cannot be recorded in operation. This is especially important for the operation of a plane or a ship. These devices need precise records for the tension variations. Thus there is an eager demand for a novel design which can improve the defect in the prior art.

### SUMMARY OF THE INVENTION

Accordingly, the primary object of the present invention is to provide an electronic tension measured spanner with a slot for connecting a memory device, in that a memory device can be connected to the spanner for recoding data in operation.

To achieve above objects, the present invention provides an electronic tension measured spanner with a slot for connecting a memory device, comprising a handle; a head extends from one end of the handle for engaging a screwing object; a display unit installed in the handle; a strain gauge installed in the head or the handle for measuring the tension in the operation of the spanner; the tension measured by the strain gauge will be transferred to the display unit for displaying; and a slot formed in the handle and electrically connected to the display unit. A memory device is insertable into the slot for receiving the data from the display unit. The slot is a USB slot. The head is one of an opened head, a ring and a socket driver. Another head is connected to another end of the handle. The memory device is a memory card or a flash disk.

The various objects and advantages of the present invention will be more readily understood from the following detailed description when read in conjunction with the appended drawing.

### BRIEF DESCRIPTION OF THE DRAWINGS

FIGS. 1 and 2 are schematic perspective views about the first embodiment of the present invention.

FIGS. 3 and 4 show the application of the present invention.

FIG. 5 is a schematic perspective views about the second embodiment of the present invention.

FIGS. 6 and 7 are schematic perspective views about the third embodiment of the present invention.

FIGS. 8 and 9 are schematic perspective views about the fourth embodiment of the present invention.

FIGS. 10 and 11 are schematic perspective views about the fifth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

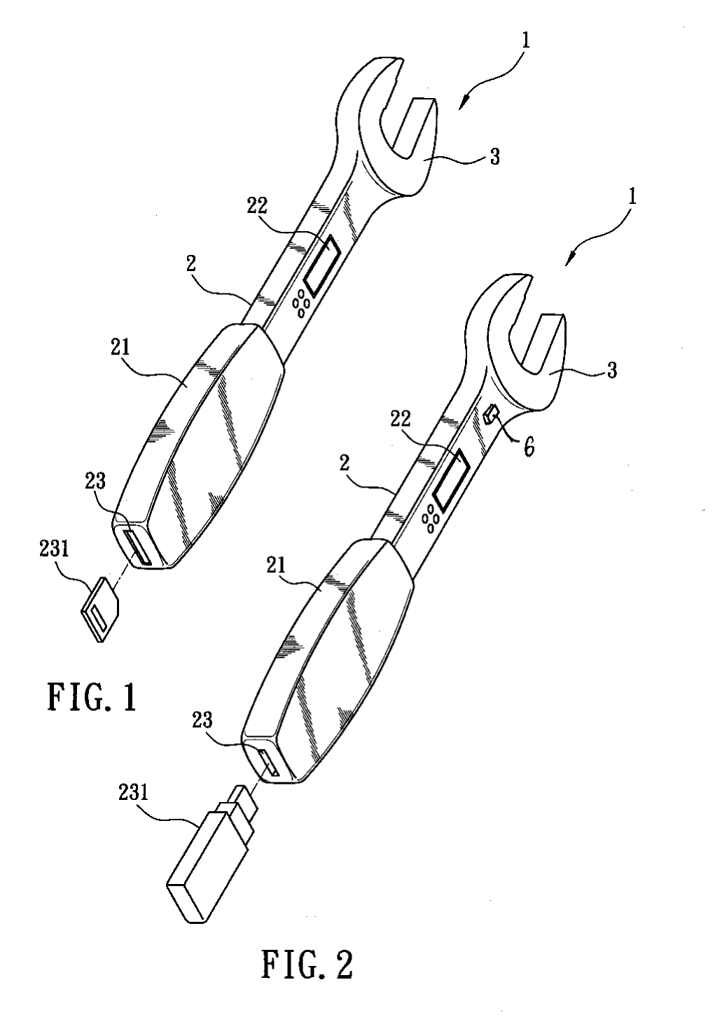

Referring to FIG. 1, the electronic tension measured spanner 1 with a slot for connecting a memory device according to the present invention is illustrated. The present invention has the following elements.

A handle 2 has a cover 21 enclosed thereon.

A head 3 extends from one end of the handle 2 for engaging a screwing object. In this embodiment, the handle 2 has a form of an opened driving unit.

The handle 2 is installed with a display unit 22.

A strain gauge 6 is installed in the head 3 or the handle 2 for measuring the tension in the operation of the spanner. In operation, the screwing object will apply a react force to the head 3 and then the force will be measured by the strain gauge 6 and then transfers to the display unit 22 so as to display the tension of the spanner.

A slot 23 is formed in the handle 2. In this embodiment, it is illustrated that the slot 23 is at one end portion of the handle 2. However it is not confined the scope of the present invention. The position of the slot may be at any desired portion of the handle 2, even at the head 3. The slot 23 is electrically connected to the display unit 22. A memory device 231, such as a memory card or a flash disk, is insertable into the slot 23 for receiving the data from the display unit 22. In the present invention, the slot 23 may be a USB slot.

In FIG. 1, it is illustrated that the memory device 231 is a memory card. In FIG. 2, it is illustrated that the memory device 231 is a flash disk.

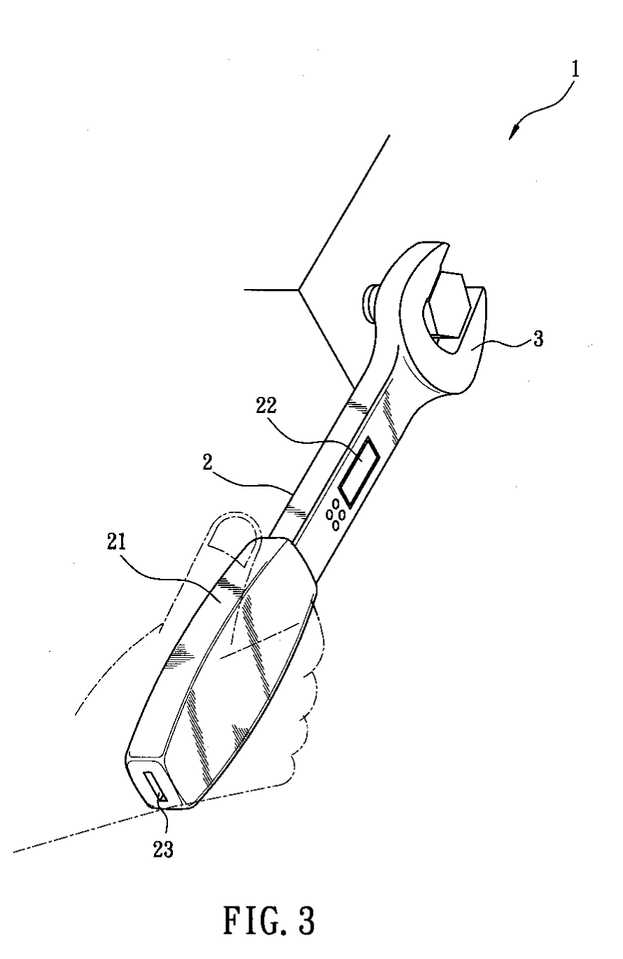

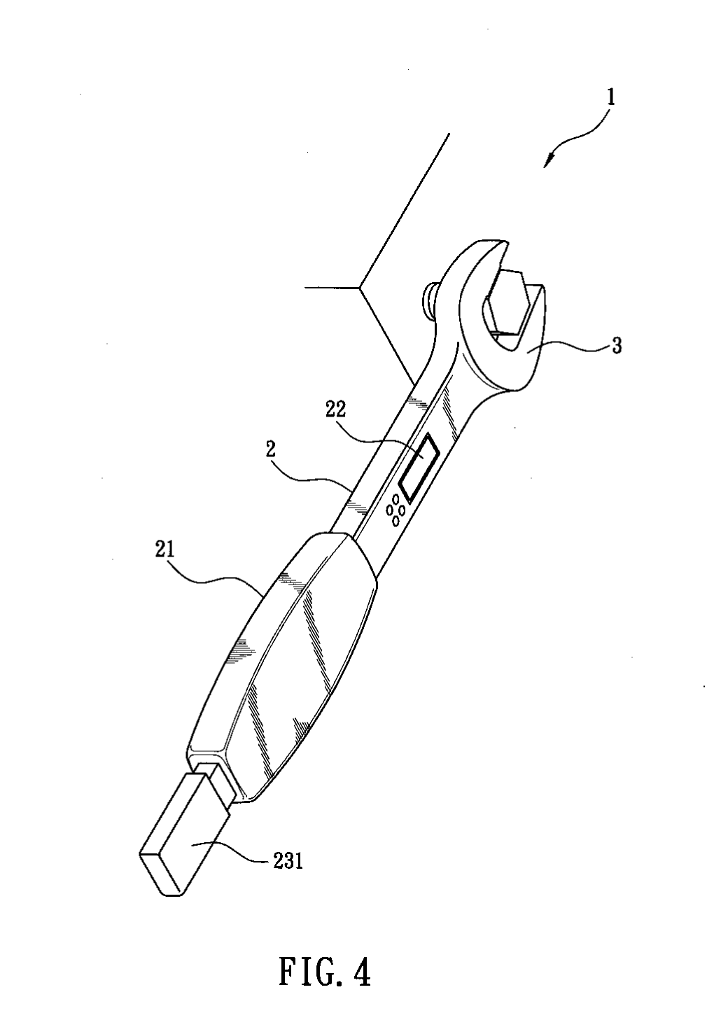

FIG. 3 shows the application of the present invention. In FIG. 3, it is illustrated that a user holds the spanner of the present invention, and the user can view the tension applied. In FIG. 4, it is illustrated that the memory device 231 is inserted into the slot 23.

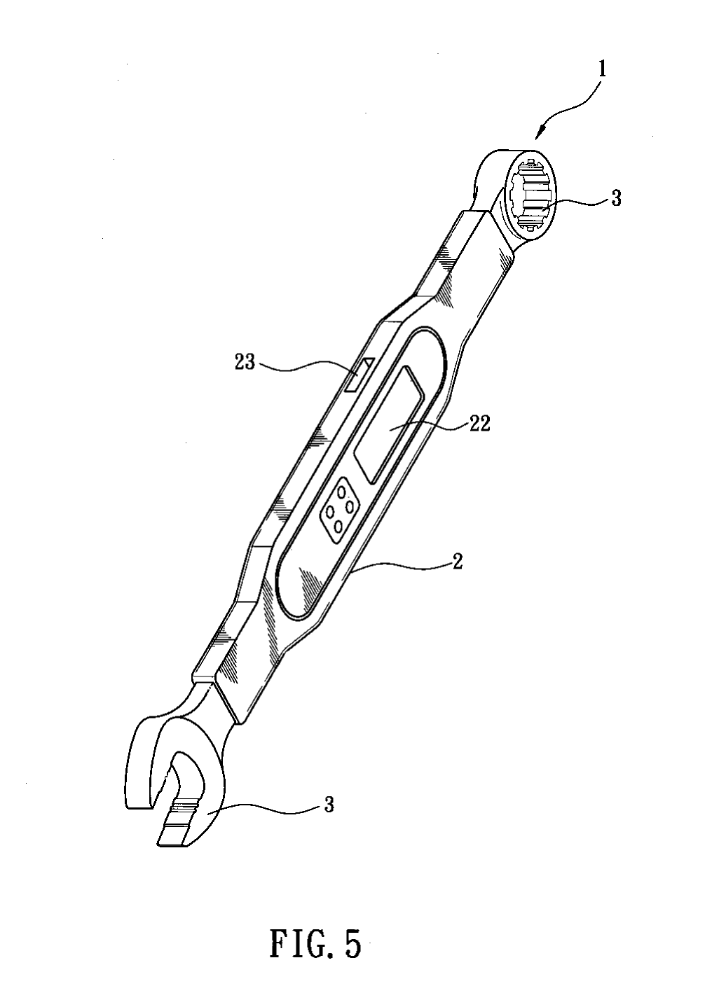

FIG. 5 shows the second embodiment of the present invention. In this embodiment, those identical to the above embodiment will not be further described herein. Only those different from above embodiment are described. In this embodiment, the spanner has two driving heads at two ends and the slot 23 is at a lateral side of the handle 2.

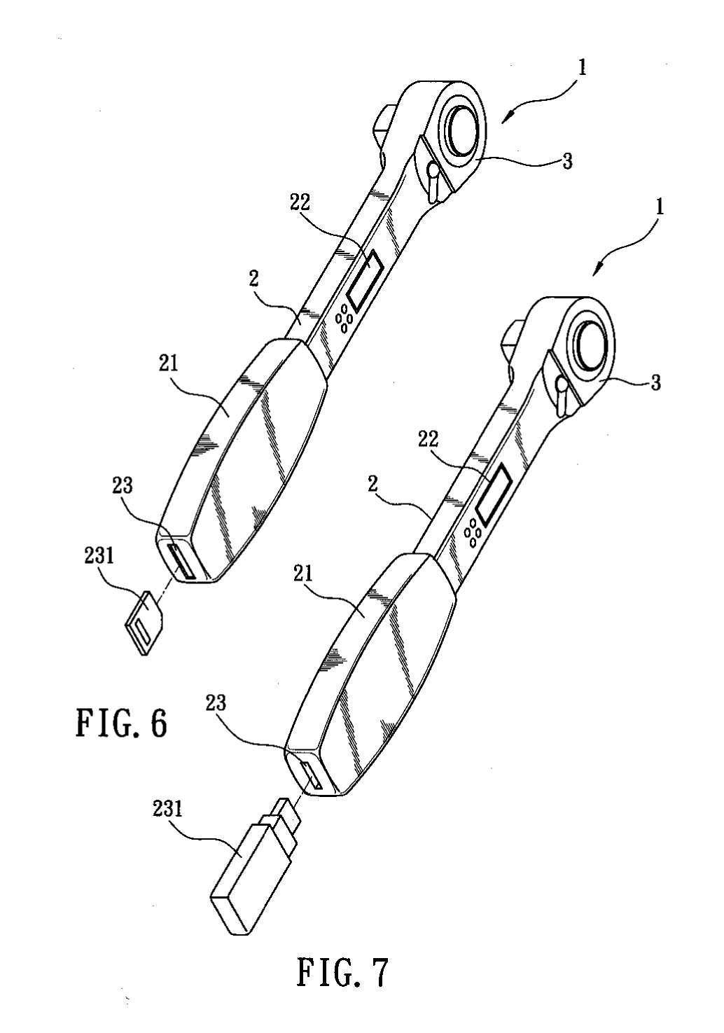

FIGS. 6 and 7 show the third embodiment of the present invention. In this embodiment, those identical to the above embodiment will not be further described herein. Only those different from above embodiment are described. In this embodiment, it is illustrated that the spanner is a socket spanner for connecting with a socket to the head.

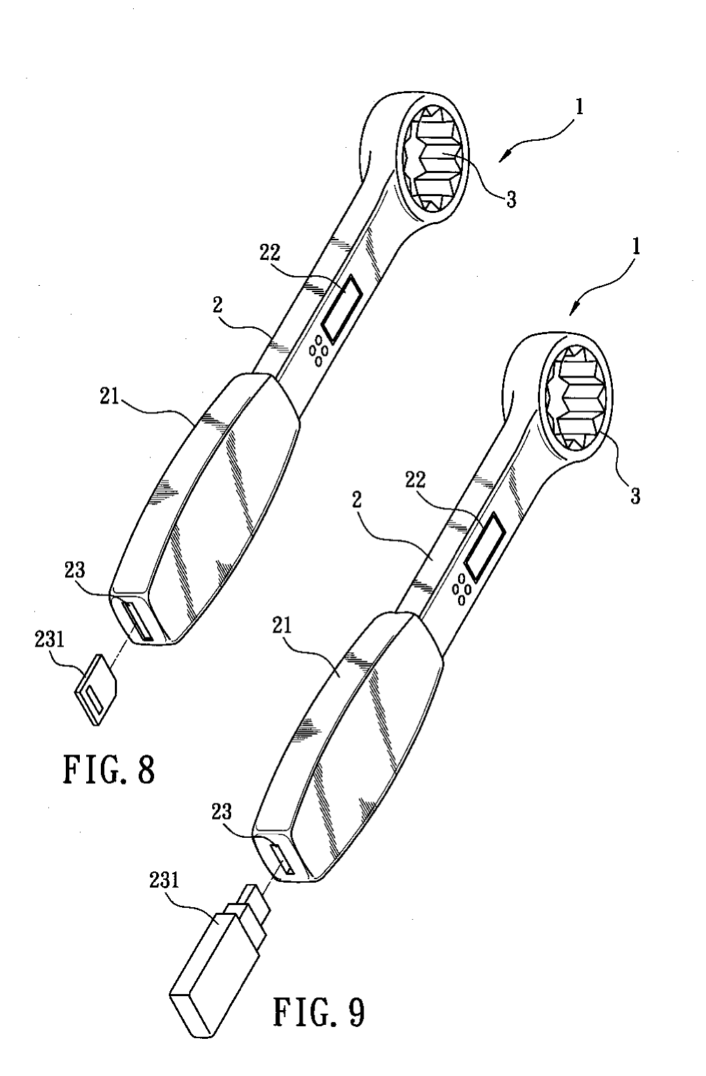

FIGS. 8 and 9 show the fourth embodiment of the present invention. In this embodiment, those identical to the above embodiment will not be further described herein. Only those different from above embodiment are described. It is illustrated that in the present invention, the handle 2 is a ring.

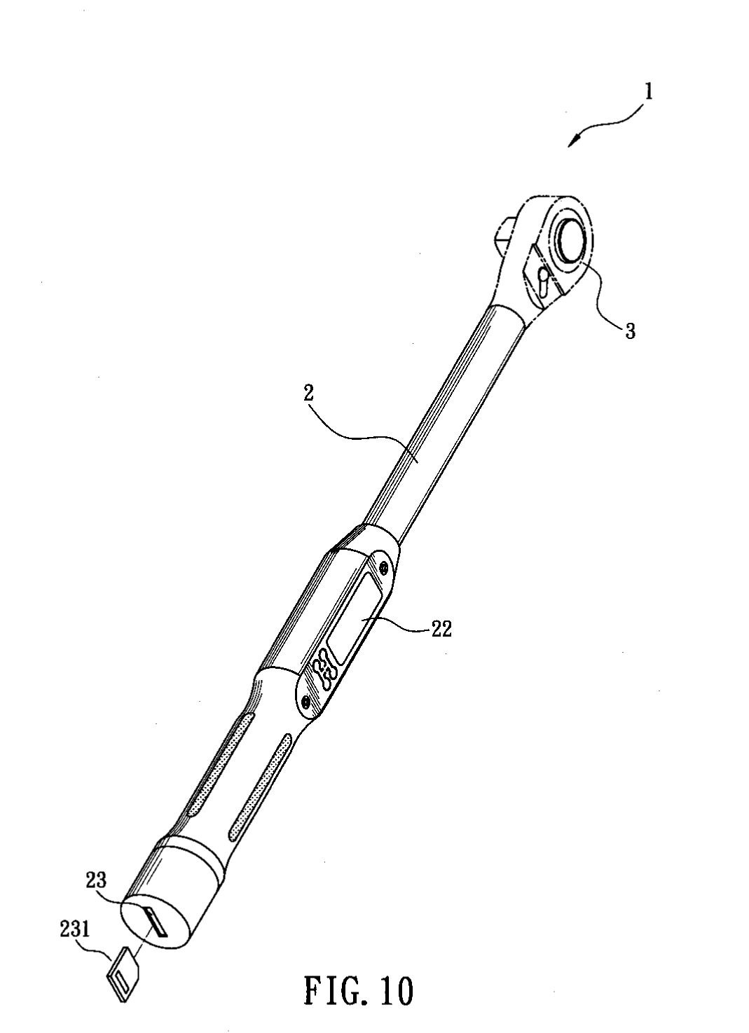

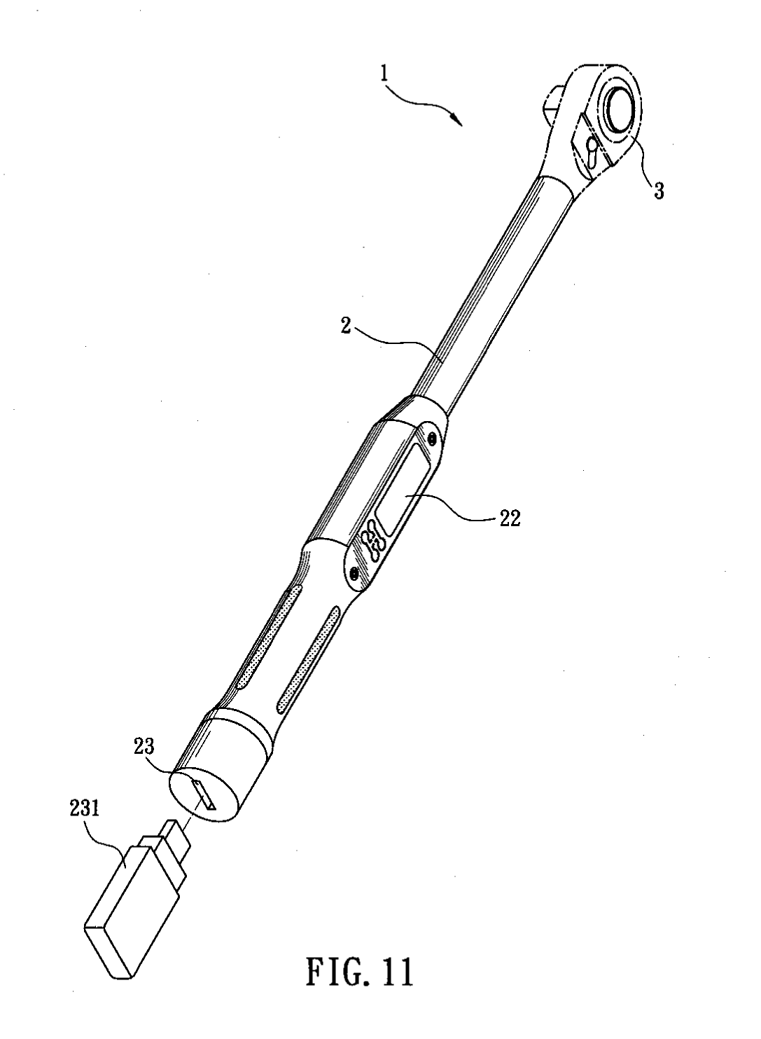

FIGS. 10 and 11 show the fifth embodiment of the present invention. In this embodiment, those identical to the above embodiment will not be further described herein. Only those different from above embodiment are described. In this embodiment, the spanner is a tension spanner and the handle 2 has a round shape.

However above mentioned embodiments are just examples of the present invention, they are not confined the scope of the present invention. The forms of the handle and head and the location of the slot may be varied as desired.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-6. (canceled)

7. An electronic tension measured spanner with a slot for connecting a memory device, comprise:
a handle (2);
a cover (21) enclosing at one end of the handle (21); the cover being formed by four lateral planes and one end plane; the four lateral planes including two flat planes at two opposite sides and two convex cambered planes at the other two opposite sides; the end plane being adjacent to the four lateral planes and being at a distal end of the handle (2);
a head (3) extending from one end of the handle (2) for engaging a screwing object; the head (3) being installed at one end of the handle (2) which is opposite to the end plane of the cover (21);
a display unit (22) being installed on the handle (2) between the head (3) and the cover (21);
a strain gauge (6) being installed on the handle (2) and between the head (3) and the display unit (22) for measuring tensions in the operation of the spanner; wherein in operation, the screwing object will apply a react force to the head (3) and then the force will be measured by the strain gauge (6) and then transfers to the display unit (22) so as to display the tension of the spanner; and
a slot (23) being formed at the end plane of the cover (2); the slot (23) being electrically connected to the display unit (22); a memory device (231) being insertable into the slot (23) for receiving the data from the display unit (22); and the slot (23) being a USB slot.

8. The electronic tension measured spanner as claimed in claim 7, wherein the memory device (231) is a memory card.

9. The electronic tension measured spanner as claimed in claim 7, wherein the memory device (231) is a flash disk.

10. The electronic tension measured spanner as claimed in claim 7, wherein the handle (2) has a form of an opened driving unit.

11. The electronic tension measured spanner as claimed in claim 7, wherein the spanner is a socket spanner for connecting with a socket to the head.

12. The electronic tension measured spanner as claimed in claim 7, wherein the spanner is a ring.

13. The electronic tension measured spanner as claimed in claim 7, wherein the spanner is a tension spanner and the handle (2) has a round shape.
